(19) United States
(12) Patent Application Publication
(10) Pub. No.: US 2013/0312062 A1
(43) Pub. Date: Nov. 21, 2013

(54) COMMUNICATION DEVICE, COMMUNICATION METHOD, COMPUTER PROGRAM, AND COMMUNICATION SYSTEM

(71) Applicant: SONY CORPORATION, Tokyo (JP)

(72) Inventor: Takashi Kuwabara, Tokyo (JP)

(73) Assignee: SONY CORPORATION, Tokyo (JP)

(21) Appl. No.: 13/890,587

(22) Filed: May 9, 2013

(30) Foreign Application Priority Data
May 17, 2012 (JP) 2012-113116

(51) Int. Cl. H04L 29/06

(52) U.S. Cl. CPC H04L 63/08
USPC 726/3

(57) ABSTRACT

There is provided a communication device including a communication unit configured to include different communication modes, and an information exchange unit configured to exchange, before the communication unit transmits information to a transmission destination device, an available communication mode and authentication information in advance with the transmission destination device using a communication mode included in the communication unit, the authentication information being used when communication is performed using the communication mode.

### BACKGROUND

The present disclosure relates to a communication device, a communication method, a computer program, and a communication system.

With the advancement of high-resolution image, the amount of data for content of still or moving images is getting larger and larger. A method of sharing content between terminals may be implemented by directly transmitting content from one terminal to another, but a large amount of content data will increase the amount of time necessary to transmit content.

In order to exchange data between terminals, from the viewpoint of security, it is desirable to perform an authentication process in advance between terminals prior to the exchange of data. A technique for performing an authentication process between terminals prior to the exchange of data is disclosed, for example, in Japanese Patent Application Laid-Open Publication Nos. 2010-011058 and 2009-140275. The technique which is disclosed in Japanese Patent Application Laid-Open Publication Nos. 2010-011058 and 2009-140275 employs a short-range communication to perform an authentication process between terminals, but it actually exchanges data using a communication mechanism that is different from the short-range communication.

### SUMMARY

However, since the communications environment is changing rapidly, when data is transferred using certain communication mechanism, the communication via the communication mechanism may be interrupted before the transfer of data is completed. According to the related art, in a case there may be a terminal having a plurality of communication mechanisms, if the communication via a communication mechanism is interrupted during data transmission and reception, there is unfortunately a need for a new authentication process to initiate the communication using another communication mechanism.

Furthermore, according to the related art, in the case where the communication via the communication mechanism is interrupted during data transmission and reception, even if the communication is initiated again using a different communication mechanism through a new authentication process, there is a need to retransmit data all over again. Under these circumstances, it is desired to provide a technology for solving the inconvenience of transferring data between terminals having a plurality of communication mechanisms.

The embodiments of the present disclosure provides a novel and improved communication device, communication method, computer program, and communication system which can continue to maintain communication between a receiver and a transmitter by causing a communication strategy to be shared in advance between them to switch among a plurality of communication mechanisms seamlessly when data is exchanged between the receiver and transmitter using the plurality of communication mechanisms.

According to an embodiment of the present disclosure, there is provided a communication device including a communication unit configured to include different communication modes, and an information exchange unit configured to exchange, before the communication unit transmits information to a transmission destination device, an available communication mode and authentication information in advance with the transmission destination device using a communication mode included in the communication unit, the authentication information being used when communication is performed using the communication mode.

Further, according to an embodiment of the present disclosure, there is provided a communication device including a communication unit configured to include different communication modes, and an information exchange unit configured to exchange, before the communication unit receives information from a transmission source device, an available communication mode and authentication information in advance with the transmission source device using a communication mode included in the communication unit, the authentication information being used when communication is performed using the communication mode.

Further, according to an embodiment of the present disclosure, there is provided a communication method including communicating using one communication mode of different communication modes, and exchanging, before information is transmitted to a transmission destination device in the communicating step, an available communication mode and authentication information in advance with the transmission destination device using a communication mode of the different communication modes, the authentication information being used when communication is performed using the communication mode.

Further, according to an embodiment of the present disclosure, there is provided a computer program for causing a computer to execute communicating using one communication mode of different communication modes, and exchanging, before information is transmitted to a transmission destination device in the communicating step, an available communication mode and authentication information in advance with the transmission destination device using a communication mode of the different communication modes, the authentication information being used when communication is performed using the communication mode.

Further, according to an embodiment of the present disclosure, there is provided a communication system including a transmitting device configured to transmit information, and a receiving device configured to directly or indirectly receive the information transmitted by the transmitting device. The transmitting device includes a communication unit configured to include different communication modes, and an information exchange unit configured to exchange an available communication mode and authentication information in advance with the receiving device using a communication mode included in the communication unit before the communication unit transmits information to the receiving device, the authentication information being used when communication is performed using the communication mode. The receiving device includes a communication unit configured to include different communication modes, and an information exchange unit configured to exchange an available communication mode and authentication information in advance with the transmitting device using a communication mode included in the communication unit before the communication unit receives information from the transmitting device, the authentication information being used when communication is performed using the communication mode.

In accordance with the embodiments of the present disclosure described above, there is provided a novel and improved communication device, communication method, computer program, and communication system which can continue to maintain communication between a receiver and a transmitter by causing a communication strategy to be shared in advance between them to switch among a plurality of communication mechanisms seamlessly when data is exchanged between the receiver and transmitter using the plurality of communication mechanisms.

### BRIEF DESCRIPTION OF THE DRAWINGS

FIG. 1 is a diagram for explaining an exemplary configuration of a communication system 1 according to an embodiment of the present disclosure;

FIG. 2 is a diagram for explaining an exemplary functional configuration of a communication device 100A that is included in the communication system 1 according to an embodiment of the present disclosure;

FIG. 3 is a flowchart illustrating a schematic operation of each of the communication devices 100A and 100B;

FIG. 4 is a diagram for explaining an example of short-range wireless communication;

FIG. 5 is a diagram for explaining an example of transmission of content data;

FIG. 6 is a flowchart illustrating an operation of each of the communication devices 100A and 100B;

FIG. 7 is a flowchart illustrating an example of communication strategic algorithm;

FIG. 8 is a flowchart illustrating an operation of each of the communication devices 100A and 100B;

FIG. 9 is a diagram for explaining an example of a case where the timeout period that is set at the time of switching of the communication mechanism is changed depending on the priority;

FIG. 10 is a flowchart illustrating an operation of each of the communication devices 100A and 100B; and

FIG. 11 is a diagram for explaining an exemplary configuration of the communication system 1 according to an embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be given in the following order.

<1. Embodiment of Present Disclosure>
[Exemplary Configuration of Communication System]
[Exemplary Configuration of Communication Device]
[Exemplary Operation of Each Communication Device]

<2. Summary and Conclusion>

### <1. Embodiment of Present Disclosure>

### [Exemplary Configuration of Communication System]

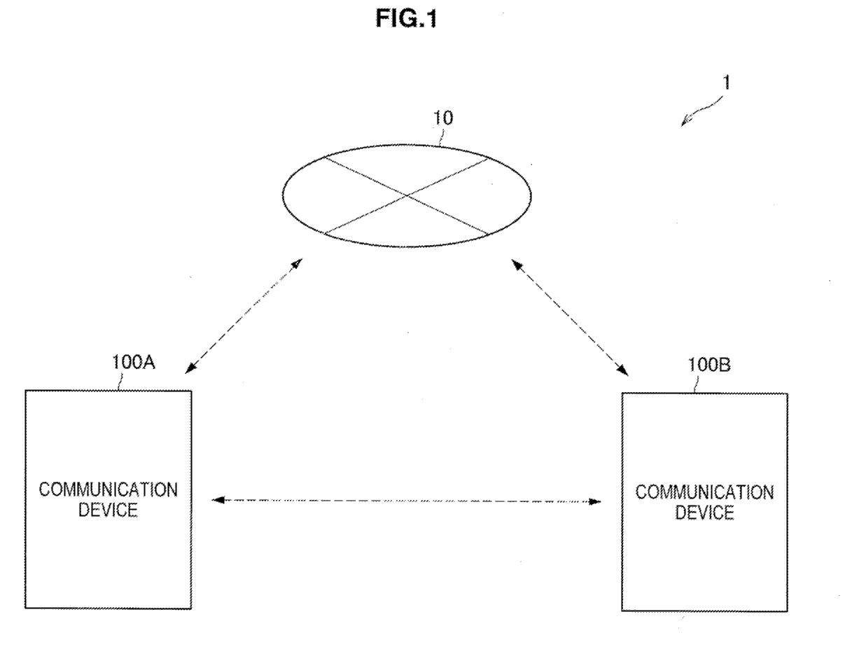

An exemplary configuration of a communication device and a communication system having the communication device according to an embodiment of the present disclosure will now be described with reference to accompanying drawings. FIG. 1 is a diagram illustrating an exemplary configuration of a communication system 1 according to the embodiment of the present disclosure. The exemplary configuration of the communication system 1 according to the embodiment of the present disclosure will now be described with reference to FIG. 1.

As illustrated in FIG. 1, the communication system according to the embodiment of the present disclosure is configured to include a communication device 100A and a communication device 100B. The communication system 1 according to the embodiment of the present disclosure is a system that is configured to exchange still or moving images, music data, or other content between these two communication devices 100A and 100B. The following description is based on operations of the case where content held by the communication device 100A is transmitted to the communication device 100B, unless otherwise stated.

In this embodiment, the communication devices 100A and 100B may be portable devices, and each of them may be any one of mobile phones, smart phones, tablets, and portable music players. Further, in the embodiment, the communication devices 100A and 100B may have the respective corresponding plurality of communication mechanisms to directly exchange data with each other using the communication mechanism. Alternatively, in the embodiment, the communication devices 100A and 100B can indirectly exchange data with each other through a server provided in a network 10, such as the Internet, in addition to the direct exchange of data by the communication mechanism.

The communication system 1 according to the embodiment is a system configured to exchange content between the communication device 100A and the communication device 100B. Therefore, the communication system 1 according to the embodiment, when exchanging content between the communication device 100A and the communication device 100B, exchanges information regarding the communication in advance between the communication device 100A and the communication device 100B, and then when actually exchanging content, the communication system 1 uses the exchanged information. Even if the communication mechanism is switched into another communication mechanism for some reasons or other at the time of exchange of content, the communication devices 100A and 100B can continue to exchange content with the communication system seamlessly.

The exemplary configuration of the communication system 1 according to the embodiment of the present disclosure has been described with reference to FIG. 1. An exemplary configuration of the communication devices 100A and 100B that are included in the communication system 1 according to the embodiment of the present disclosure will now be described.

### [Exemplary Configuration of Communication Device]

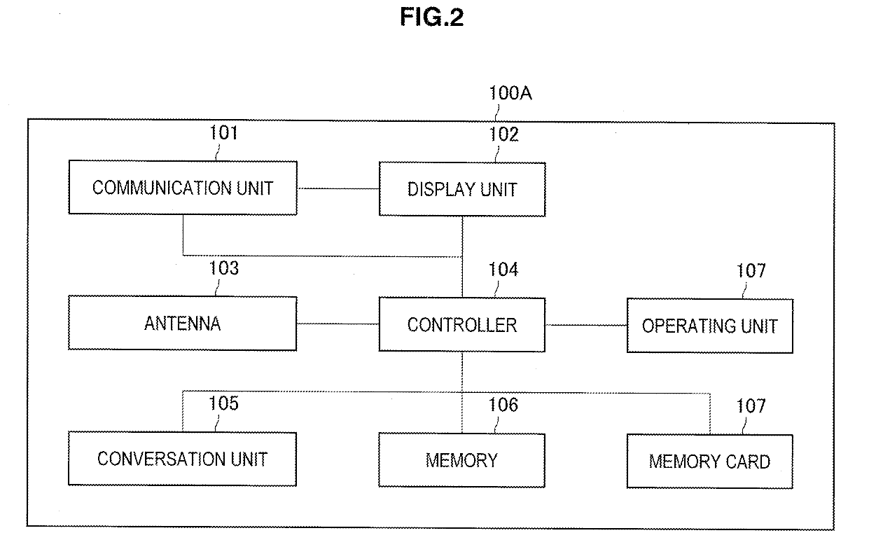

FIG. 2 is a diagram illustrating an exemplary functional configuration of the communication device 100A that is included in the communication system 1 according to the embodiment of the present disclosure. The exemplary functional configuration of the communication device 100A according to the embodiment of the present disclosure will now be described with reference to FIG. 2.

As illustrated in FIG. 2, the communication device 100A according to the embodiment of the present disclosure is configured to include a wireless communication unit 101, a display unit 102, an antenna 103, a controller 104, a conversation unit 105, a memory 106, an operating unit 107, and a memory card 108.

The communication unit 101 communicates with other devices, especially the communication device 100B, over a wired or wireless network. In this embodiment, the communication unit 101 may have a plurality of communication mechanisms. The communication mechanism of the communication unit 101 may include, for example, wireless communication of IEEE 802.15.1 standards, wireless communication of IEEE 802.11 series standards such as Wi-Fi, wired communication via LAN or USB cable, and so on.

The display unit 102 displays information which is received by the wireless communication unit 101 or information obtained in response to user's operation performed for the operating unit 107. For example, the display unit 102 may include a flat panel image display such as a liquid crystal display and an organic EL display. A touch panel may be provided on a display surface of the display unit 102.

The antenna 103 is an antenna for short-range wireless communication which operates at a given frequency (e.g., 13.56 MHz). The controller 104 controls operations of the communication device 100A. For example, the controller 104 controls operations of the components of the communication device 100A by executing the program stored in the memory 106. An operation of the communication device 100A which is controlled by the controller 104 may include, for example, the display of information on the display unit 102, the communication performed by the communication unit 101 or the antenna 103, and so on.

The conversation unit 105 includes, for example, a speaker or a microphone, and performs a voice telephone conversation with other devices or telephone sets. The memory 106 may include, for example, a ROM, a RAM, and so on, and may be used to store the program for controlling the operation of the communication device 100A. The operating unit 107 includes various types of buttons that are used to operate the communication device 100A. In response to the operation of the operating unit 107, the controller 104 controls the operation of the communication device 100A. In addition, if a touch panel is provided on a display surface of the display unit 102, then the touch panel functions as the operation unit 107.

The memory card 108 is a storage medium for storing various types of information, and may be configured to be removable from the communication device 100A. In addition, the memory card 108 stores still or moving images, music data, or other content data. The content data which is stored in the memory card 108 is transmitted from the communication unit 101 to the communication device 100B by the controller 104.

The exemplary functional configuration of the communication device 100A is illustrated in FIG. 2. The communication device 100B has a substantially similar configuration to that of the communication device 100A. The controller 104 of the communication device 100A exchanges available communication mode and authentication information in advance with the communication device 100B. This exchange of the communication mode and authentication information is performed via short-range wireless communication using the antenna 103 before the communication device 100A transmits information to the communication device 100B. The authentication information is information necessary when the communication is performed based on the available communication mode. Because the controller 104 performs the exchange of the communication mode and authentication information before transmitting content, even if the communication mechanism being used for transmitting content is switched for some reasons when the communication device 100A transmits content to the communication device 100B, the communication device 100A can continue to transmit content seamlessly.

The exemplary functional configuration of the communication device 100A according to the embodiment of the present disclosure has been described with reference to FIG. 2. Next, the operation of the communication devices 100A and 100B that are included in the communication system 1 according to the embodiment of the present disclosure will now be described.

### [Exemplary Operation of Each Communication Device]

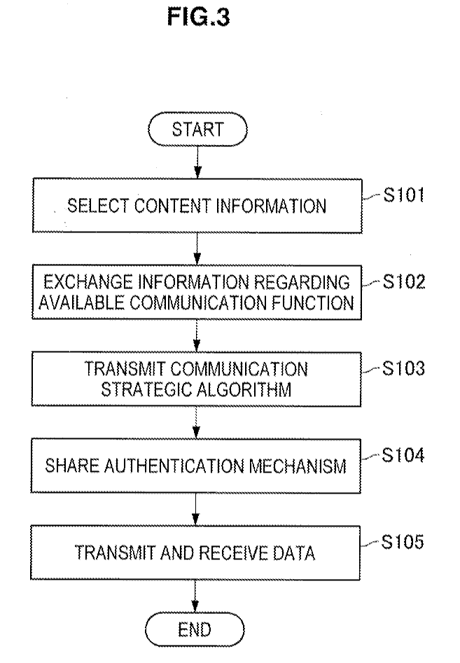

FIG. 3 is a flowchart illustrating a schematic operation of each of the communication devices 100A and 100B that are included in the communication system 1 according to the embodiment of the present disclosure. The flowchart illustrated in FIG. 3 shows an overview of the operation performed by each of the communication devices 100A and 100B when the communication device 100A transmits content to the communication device 100B. An overview of the operation performed by each of the communication devices 100A and 100B that are included in the communication system 1 according to the embodiment of the present disclosure will now be given with reference to FIG. 3.

When transmitting content to the communication device 100B, the communication device 100A selects the content to be transmitted to the communication device 100B (step S101). The selection of content which is performed by the communication device 100A in step S101 is not limited to any particular method. As an example, in the communication device 100A, the controller 104 may cause the display unit 102 to display a list of contents and thus cause a user to select content from the list that is to be transmitted to the communication device 100B.

In the above step S101, when the content to be transmitted to the communication device 100B has been selected by the communication device 100A, then the communication device 100A exchanges information regarding available communication functions with the communication device 100B (step S102). This exchange process of information in this step S102 may be performed, for example, by the controller 104. In step S102, when the communication device 100A has exchanged information regarding the available communication functions with the communication device 100B, then the communication device 100A transmits a communication strategic algorithm to the communication device 100B (step S103). The communication strategic algorithm is used to determine a method for selecting a communication mechanism to be used when the communication device 100A exchanges content with the communication device 100B. This transmission process may be performed, for example, by the communication unit 101. The communication device 100A then shares an authentication mechanism with the communication device 100B (step S104). The authentication mechanism is used when the communication device 100A communicates with the communication device 100B.

When the exchange of information regarding available communication functions, the transmission of a communication strategic algorithm, and the sharing of an authentication mechanism have been performed, the communication device 100A then transmits content data which is selected in step S101 to the communication device 100B (step S105). This transmission process of content data may be performed, for example, by the communication unit 101. At the time of transmission of the content data, the communication device 100A selects one communication function among the communication functions exchanged in step S102 based on the communication strategic algorithm transmitted in step S103, and then performs an authentication process with the communication device 100B by the authentication mechanism shared in step S104.

The exchange of information regarding available communication functions, the transmission of a communication strategic algorithm, and the sharing of an authentication mechanism are performed via short-range wireless communication using the antenna 103 in a state in which the communication devices 100A and 100B are in close proximity to each other. Because the short-range wireless communication is communication technology which can be implemented only at a close range, the authentication performed via short-range wireless communication between the communication devices 100A and 100B may be a simple authentication process which shows just the fact that they are equipments which have initiated the communication with each other at the same time.

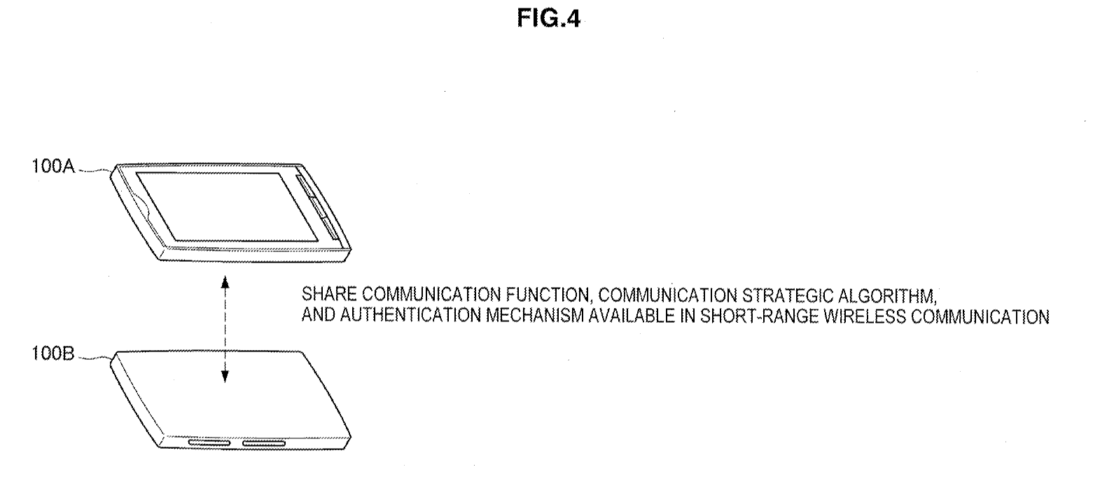

FIG. 4 is a diagram for explaining an example of short-range wireless communication performed in a state in which the communication devices 100A and 100B are in close proximity to each other. When content data is exchanged between the communication device 100A and the communication device 100B, as illustrated in FIG. 4, the communication devices 100A and 100B are to be in close proximity to each other before the communication device 100A transmits the content data to the communication device 100B. The short-range wireless communication which is performed between the communication devices 100A and 100B then allows the available communication function, communication strategic algorithm, and authentication mechanism to be shared between the communication devices 100A and 100B.

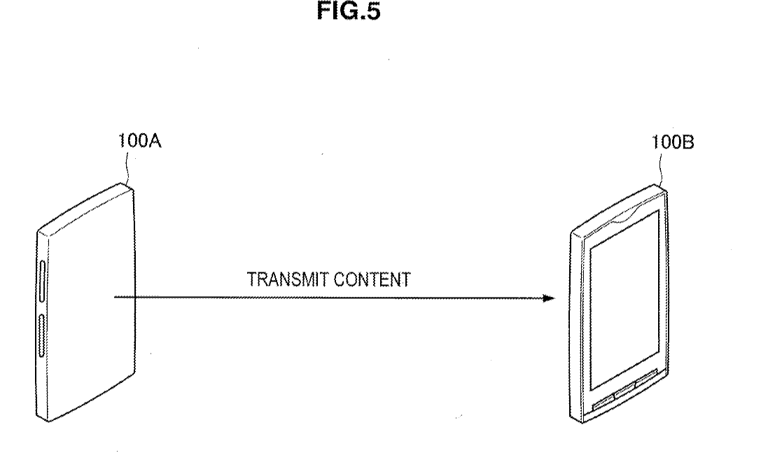

FIG. 5 is a diagram for explaining an example of the transmission of content data from the communication device 100A to the communication device 100B. After the available communication functions, communication strategic algorithm, and authentication mechanism are shared between the communication devices 100A and 100B via short-range wireless communication, the transmission of content data from the communication device 100A to the communication device 100B is performed even in a state in which the communication devices 100A and 100B are separated from each other, as shown in FIG. 5. The communication device 100A, when transmitting content data to the communication device 100B, uses information of the available communication function, communication strategic algorithm, and authentication mechanism, which have been exchanged with the communication device 100B.

The overview of the operation performed by each of the communication devices 100A and 100B that are included in the communication system 1 according to the embodiment of the present disclosure has been described with reference to FIG. 3. Next, the operation performed by the communication devices 100A and 100B that are included in the communication system 1 according to the embodiment of the present disclosure will now be described in detail.

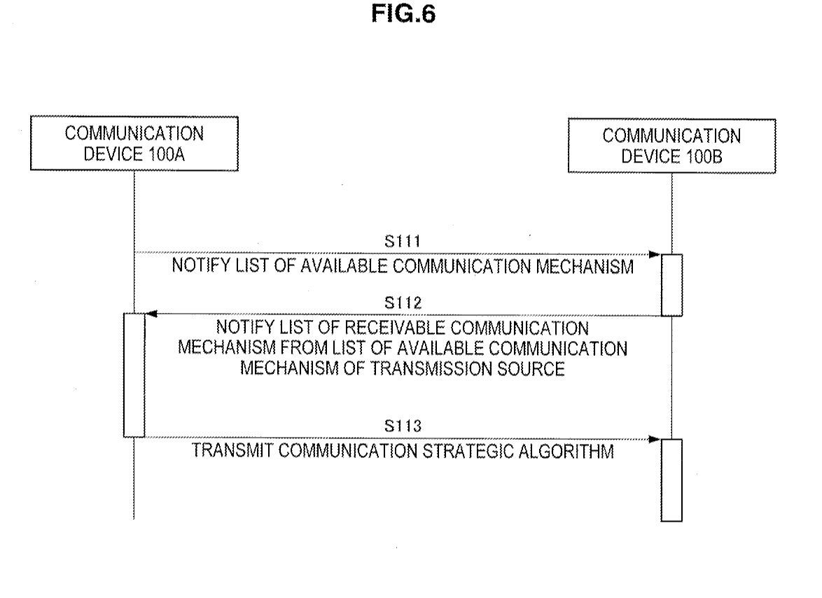

FIG. 6 is a flowchart illustrating an operation of the communication devices 100A and 100B that are included in the communication system 1 according to the embodiment of the present disclosure. The flowchart of FIG. 6 shows in further detail the processes performed in steps S102 and S103 shown in FIG. 3. The operation of the communication devices 100A and 100B will now be described with reference to FIG. 6.

The communication device 100A, when exchanging information regarding the available communication function with the communication device 100B, notifies a list of communication mechanisms available on its own device to the communication device 100B (step S111). The list of communication mechanisms available on its own device is notified to the communication device 100B, for example, via short-range wireless communication using the antenna 103 by the controller 104.

The list of communication mechanisms available on its own device includes, for example, a desired priority policy that defines the priority level of communication mechanism or a list of communication types. The list of communication types includes, for example, information such as communication types, available communication options, a typical transmission or reception speed, a typical communication coverage, parameters that give the attenuation curve of communication rate according to the distance (in the case of wireless communication), timeout period, and so on. In addition, the communication types include, for example, wired P2P (Peer to Peer) such as USB, short-range wireless P2P such as NFC, wireless P2P such as Wi-Fi ad hoc communication or Bluetooth communication, P2P via a network such as the Internet, and the use of a mediation server on a network such as the Internet.

A communication mode to be used in preference to other modes is specified by the desired priority policy. For example, when wireless P2P such as Wi-Fi ad hoc communication or Bluetooth communication is used preferentially in order for the communication device 100A to exchange data with the communication device 100B, the communication device 100A specifies the wireless P2P to be used preferentially.

In step S111, if the list of communication mechanisms available on the communication device 100A is transmitted via short-range wireless communication from the communication device 100A to the communication device 100B, then the communication device 100B notifies a receivable list of communication mechanisms from among the received list of communication mechanisms to the communication device 100A (step S112). This notification of step S112 is performed via short-range wireless communication, which is the same as that of step S111.

In step S112, if the list of communication mechanisms which can be received by the communication device 100B is transmitted via short-range wireless communication from the communication device 100B to the communication device 100A, then the communication device 100A transmits a communication strategic algorithm to the communication device 100B (step S113). In this case, the communication strategic algorithm is used to determine a method for selecting a communication mechanism to be used when the communication device 100A communicates with the communication device 100B. The transmission in step S113 is performed via short-range wireless communication, which is the same as that of step S111 or S112.

In this way, the exchange of available communication functions or the sharing of communication strategic algorithm is performed in advance between the communication devices 100A and 100B, prior to exchanging content data between them. By performing the exchange of available communication functions or the sharing of communication strategic algorithm, and further by performing the sharing of an authentication mechanism between the communication devices 100A and 100B, the communication devices 100A and 100B can continue to exchange content seamlessly.

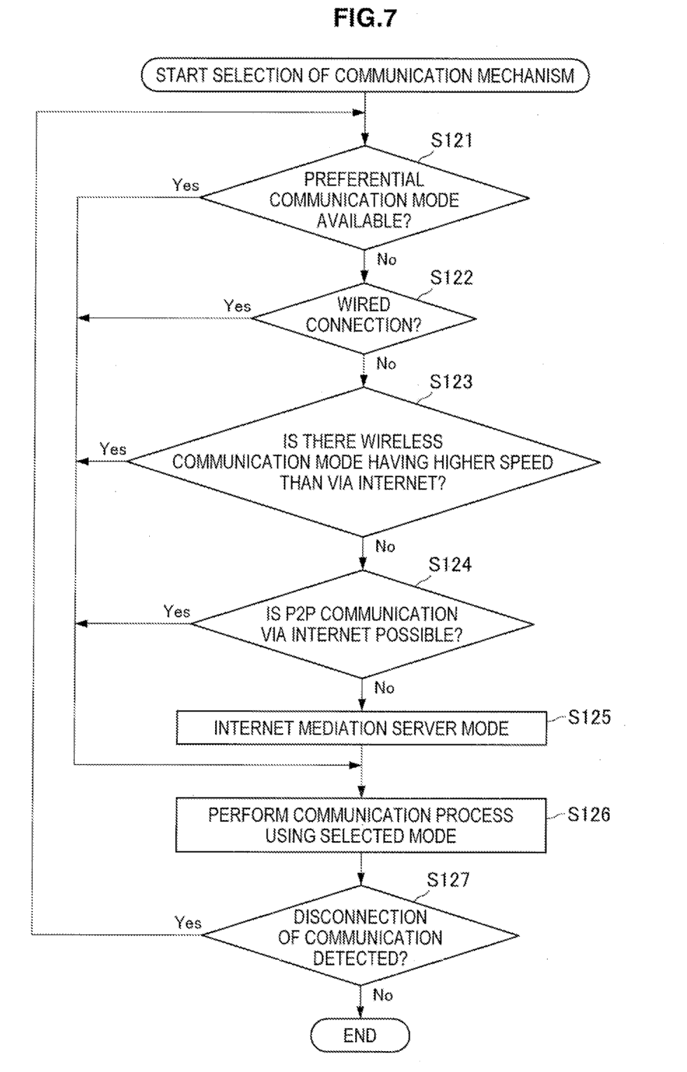

An example of a communication strategic algorithm which is shared between the communication devices 100A and 100B will now be described. FIG. 7 is a flowchart illustrating an example of the communication strategic algorithm which is shared between the communication devices 100A and 100B according to the embodiment of the present disclosure. An example of the communication strategic algorithm that is shared between the communication devices 100A and 100B will now be described with reference to FIG. 7.

In order to select a communication mechanism to be used between the communication devices 100A and 100B from among the available communication mechanisms, it is determined whether a preferential communication mode that is specified to be used preferentially from among the available communication modes is available (step S121). The preferential communication mode is specified based on the desired priority policy described above.

In step S121, if it is determined that the preferential communication mode that is specified to be used preferentially from among the available communication mechanisms between the communication devices 100A and 100B is not available, then it is determined whether the communication devices 100A and 100B are connected to each other by a wired connection (step S122).

In step S122, if it is determined that the communication devices 100A and 100B are not connected to each other by a wired connection, then it is determined whether there is a wireless communication mode having a higher speed than via a network, such as the Internet, from among the communication mechanisms available between the communication devices 100A and 100B (step S123).

In step S123, it is determined that there is no wireless communication mode having a higher speed than via a network such as the Internet from among the communication mechanisms available between the communication devices 100A and 100B, then it is determined whether P2P communication via a network such as the Internet is available (step S124).

In step S124, if it is determined that P2P communication via a network such as the Internet is not available, then the content data is determined to be exchanged between the communication devices 100A and 100B using a mode in which the exchange is performed via a mediation server provided on the network such as the Internet (step S125).

On the other hand, in steps S121 through S124, if any one of the above-described conditions is satisfied, it is determined that the communication devices 100A and 100B select a communication mode which satisfies each of the conditions, and then the communication process is performed using the selected communication mode (step S126).

Subsequently, it is determined whether a disconnection of communication is detected during the exchange of content data (step S127). If it is determined that a disconnection of communication is detected, then the process is returned to step S121 and the determination processes are repeated. On the other hand, if it is determined that a disconnection of communication is not detected, then the communication strategic algorithm is terminated.

In this way, a communication strategic algorithm is determined and the determined communication strategic algorithm is shared between the communication devices 100A and 100B in advance. Therefore, even if the communication is disconnected during the exchange of content data, the communication devices 100A and 100B can continue to exchange content seamlessly by switching the communication mechanism into another.

An example of dynamic switching of communication mechanism when content data is exchanged between the communication devices 100A and 100B will now be described.

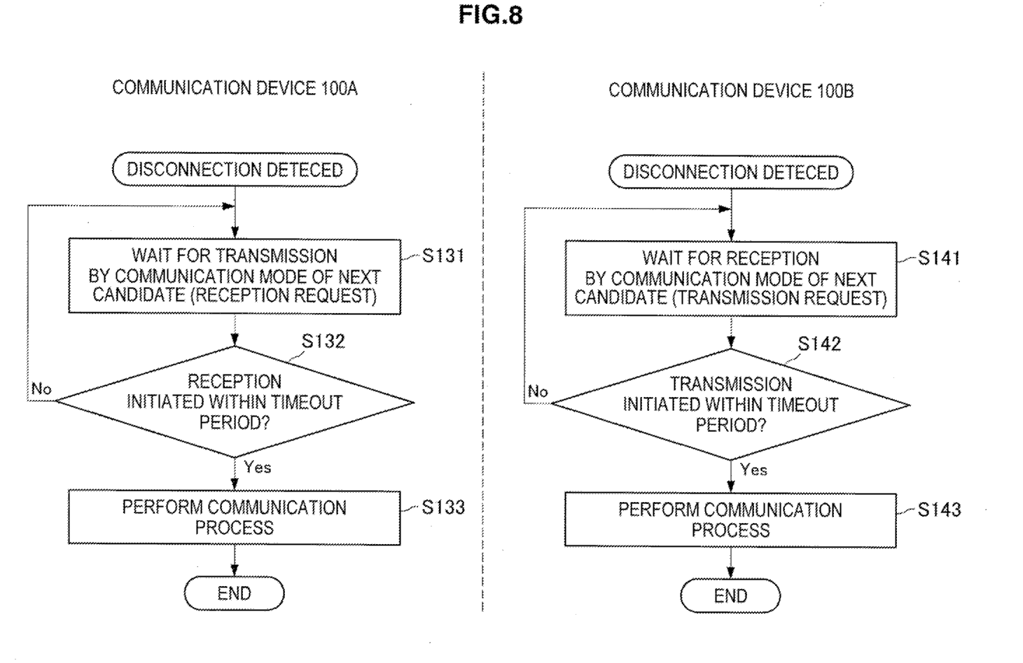

FIG. 8 is a flowchart illustrating an operation of each of the communication devices 100A and 100B that are included in the communication system 1 according to the embodiment of the present disclosure. The flowchart of FIG. 8 illustrates the operation of the case where the communication is disconnected when data is exchanged between the communication devices 100A and 100B. The operation of the communication devices 100A and 100B that are included in the communication system 1 according to the embodiment of the present disclosure will now be described with reference to FIG. 8.

If the communication devices 100A and 100B detect a disconnection of the communication performed using the communication mechanism by which data has been exchanged, then the source communication device 100A waits for transmission (reception by the communication device 100B is requested) to be performed using a communication method which is the next candidate to be determined by the communication strategic algorithm (step S131). In addition, the destination communication device 100B waits for reception (transmission by the communication device 100A is requested) performed using the communication method that is the next candidate to be determined by the communication strategic algorithm (step S141).

Subsequently, the communication device 100A determines whether the communication device 100B initiates reception within a predetermined timeout period (step S132), and the communication device 100B determines whether the communication device 100A initiates transmission within a predetermined timeout period (step S142). If it is determined that the reception is initiated by the communication device 100B, then the communication device 100A performs a corresponding communication process based on the communication mode which is determined in step S131 (step S133). If it is determined that the transmission is initiated by the communication device 100A, then the communication device 100B performs a corresponding communication process based on the communication mode which is determined in step S141 (step S143). If it is determined that the reception is not initiated by the communication device 100B, then the process is returned to step S131, and the communication device 100A waits for transmission to be performed using a communication method that is the next candidate determined by the communication strategic algorithm. If it is determined that the transmission is not initiated by the communication device 100A, then the process is returned to step S141, and the communication device 100B waits for reception to be performed using the communication method that is the next candidate determined by the communication strategic algorithm.

Furthermore, each process performed by the communication devices 100A and 100B illustrated in FIG. 8 is performed independently, not in synchronization with each other. Because a disconnection of communication is detected independently by each of the communication devices 100A and 100B, the subsequent processes will be performed independently by each of the communication devices 100A and 100B.

The process illustrated in FIG. 8 will be described in detail with reference to the following example. By causing the communication devices 100A and 100B to be in close proximity to each other as shown in FIG. 4 and thus by performing short-range wireless communication, the sharing of content is initiated between the communication devices 100A and 100B. However, there is not necessary to continue to cause the communication devices 100A and 100B to be in close proximity to each other until the sharing of content between the communication devices 100A and 100B is completed. The communication devices 100A and 100B may be spaced away from each other such that the communication between them is no longer performed.

If a disconnection of short-range wireless communication is detected, each of the communication devices 100A and 100B specifies a new communication mechanism based on the communication strategic algorithm which has been shared at the time of initiating the communication, as shown in FIG. 7. For example, it is assumed that Bluetooth (registered trademark) is specified as a new communication mechanism based on the communication strategic algorithm.

Subsequently, each of the communication devices 100A and 100B checks whether the communication performed using the new communication mechanism is available. In this case, because an authentication process of the communication devices 100A and 100B is performed by the previously exchanged authentication mechanism, the communication can be initiated automatically with a new communication mechanism without performing a new authentication process.

If the communication using Bluetooth (registered trademark) is disconnected during the exchange of data, then the communication devices 100A and 100B specify a new communication mechanism based on the communication strategic algorithm. In this case, when the communication is re-established within a predetermined timeout period, the communication that uses the new communication mechanism is resumed. When the communication using the new communication mechanism is resumed, the communication devices 100A and 100B continue to exchange content data without re-transmitting data which has previously exchanged.

In addition, the timeout period that is set at the time of switching of the communication mechanism may be dependent on the priority. For example, the timeout period becomes shorter as the priority becomes higher, and the timeout period becomes longer as the priority becomes lower. By setting the timeout period in this way, the communication devices 100A and 100B can reduce the time taken until the establishment of communication that uses a communication mode having a higher priority. In addition, if the time necessary for switching of communication mode is constant, then consequently it is possible to reduce the time taken until the re-establishment of communication that uses a communication mode.

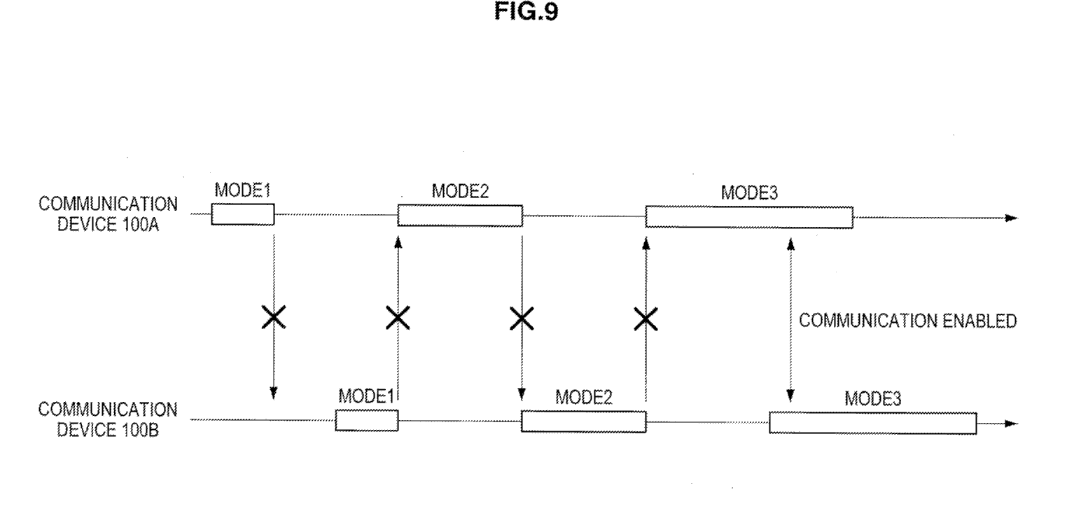

FIG. 9 is a diagram for explaining an example of the case where the timeout period that is set at the time of switching of communication mechanisms is changed depending on the priority. Three communication modes are illustrated in FIG. 9. In FIG. 9, the length of timeout period of each communication mode is shown in a rectangular shape. FIG. 9 also illustrates the case where the priority is decreasing in the order of mode1, mode1, and mode3. In this way, by setting the timeout period, the communication devices 100A and 100B can reduce the time taken until the communication is re-established using the mode3.

A coverage area in which communication can be performed via short-range wireless communication is very narrow, and is highly dependent on the distance between devices. Therefore, in some cases, the switching from the present communication mechanism to another communication mechanism is desired immediately after the sharing process of the authentication mechanism shown in step S104 of FIG. 3 is terminated. An operation of such a case will be described.

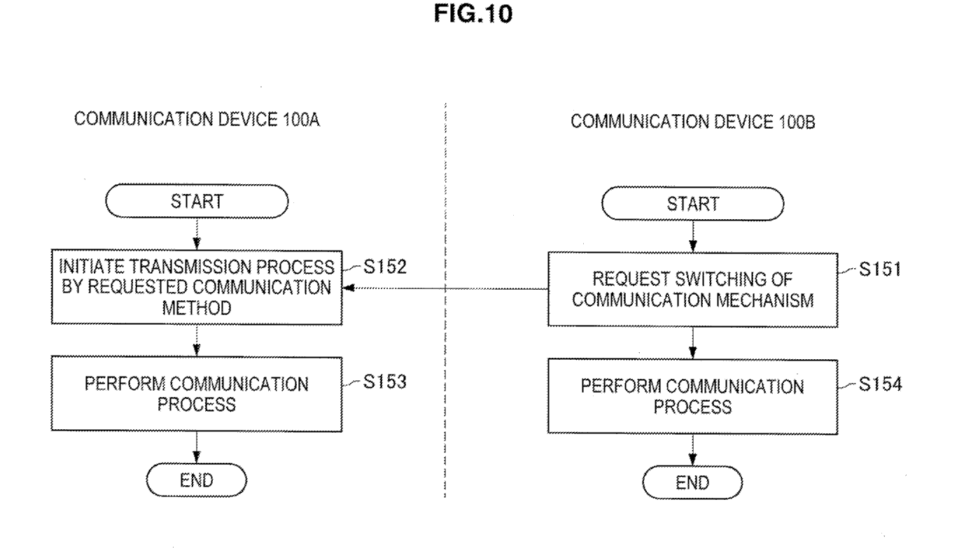

FIG. 10 is a flowchart illustrating an operation of each of the communication devices 100A and 100B that are included in the communication system 1 according to the embodiment of the present disclosure. The flowchart of FIG. 10 illustrates an operation of the case where the switching of communication mode is requested from the receiving-side communication device 100B when data is exchanged between the communication devices 100A and 100B. The operation of each of the communication devices 100A and 100B that are included in the communication system 1 according to the embodiment of the present disclosure will now be described with reference to FIG. 10.

When the sharing process of authentication mechanism via shot-range wireless communication between the communication devices 100A and 100B is terminated, the communication device 100B transmits a request for switching of communication mechanism to the communication device 100A (step S151). The communication device 100A, when receiving the request for switching of communication mechanism from the communication device 100B, initiates a transmission process using the requested communication mode (step S152).

Subsequently, each of the communication devices 100A and 100B performs the corresponding communication process according to the flowchart shown in FIG. 3 (steps S153 and S154), and performs the exchange of content data. In addition, the communication device 100A excludes the short-range wireless communication in advance from among the available communication modes exchanged in step S102 of the flowchart shown in FIG. 3.

Since the short-range wireless communication is excluded in advance from among the available communication modes exchanged in step S102 of the flowchart shown in FIG. 3, the communication via short-range wireless communication can be excluded from selectable candidates in the subsequent communications. In addition, by performing such a process, the communication devices 100A and 100B can dynamically exclude a communication mechanism, which has a high communication priority but is unstable. In addition, even when the case where the communication mechanism, which has been not available at the time of initiating the communication, becomes available depending on the change in the surrounding environments, a new communication mechanism can be incorporated into the communication strategic algorithm by performing the process described above.

Moreover, in the flowchart shown in FIG. 10, the receiving-side communication device 100B transmits a request for switching of communication mechanism, or alternatively the transmitting-side communication device 100A may transmit a request for switching of communication mechanism.

Subsequently, when P2P communication is not enabled between the communication devices 100A and 100B, a method of exchanging content data between the communication devices 100A and 100B using a mediation server provided on a network will now be described.

In the switching process of communication mechanism shown in FIG. 8, when the P2P communication has timed-out entirely, the source communication device 100A changes the destination of content into a cloud or dedicated server on the network 10 according to the communication strategic algorithm which is shared in the flowchart shown in FIG. 3. At this time, in order to reduce the time necessary to receive and transmit content, the source communication device 100A may transmit preferentially content that have not yet transmitted.

The destination communication device 100B may obtain the content that is uploaded by the communication device 100A using the specified authentication mechanism (an ID or password). The content is uploaded into a cloud or dedicated server on the network 10 specified based on the communication strategic algorithm which is shared in the flowchart shown in FIG. 3.

In addition, when there are no content in a cloud or dedicated server on the network 10 at the time of checking by the destination communication device 100B, the communication device 100B performs a polling operation on a cloud or dedicated server on the network 10 for a certain period of time or at a certain number of times. The polling operation is performed based on information that is shared in the flowchart shown in FIG. 3.

In this example, there may be considered the case where a cloud or a server on the network 10 does not take over the middle of transmission of content. In order to use effectively data received at the time of reception and transmission in P2P communication, when data is obtained from a cloud or a server on the network 10, it is preferable to be able to exchange only data that has not yet transmitted. However, there may be also cases where a cloud or a server on the network 10 performs the uploading or downloading of the same content in parallel, or a cloud or a server on the network 10 has no function that downloads only a portion of data that is uploaded halfway.

When content information is exchanged between the communication devices 100A and 100B using the process shown in FIG. 3, transmission division information and hash information are shared in advance between the communication devices 100A and 100B. In addition, the unit of transmission division may be optionally determined in accordance with communication environments. Thus, the exchange of content data between the communication devices 100A and 100B is performed in the units defined by the transmission division information.

The communication devices 100A and 100B, when exchanging data via a cloud or a server on the network 10, regard the previously shared hash information as key information and specify a portion of content, thereby performing the reception or transmission. By regarding the previously shared hash information as key information, the communication devices 100A and 100B can realize the pseudo parallel execution of the uploading and downloading of content.

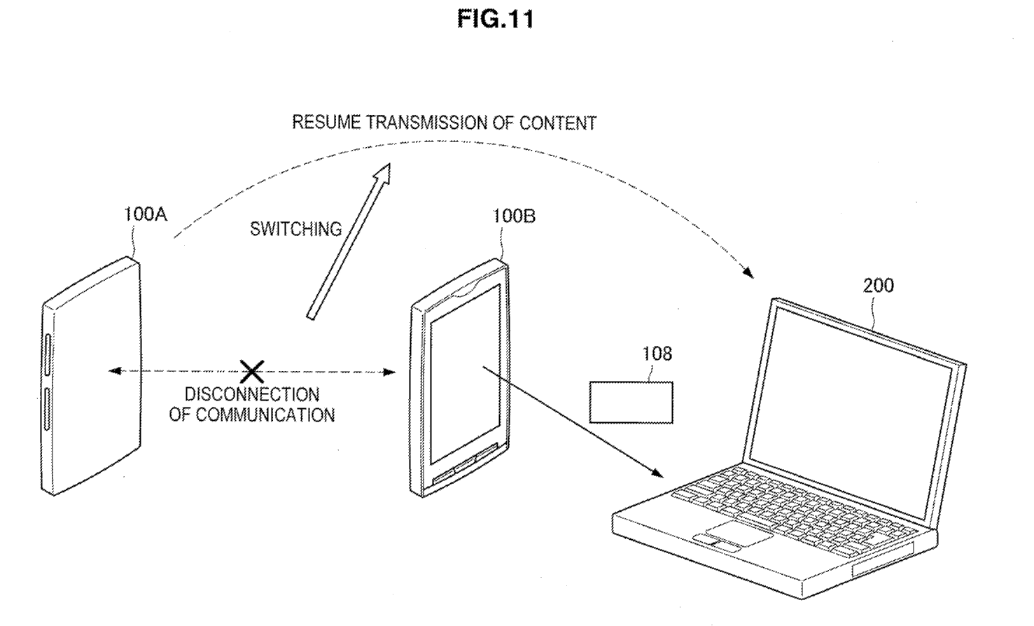

The procedure for switching of a communication method in the case where a recording medium which is used to share content between the communication devices 100A and 100B can be further connected to other devices will be described. FIG. 11 is a diagram for explaining an exemplary configuration of the communication system 1 according to the embodiment of the present disclosure. FIG. 11 illustrates a personal computer 200 in addition to the communication devices 100A and 100B. The personal computer 200 is configured to be connectable with a memory card 108 of the communication device 100B.

The communication device 100B stores the communication strategic algorithm and authentication information on the memory card 108. The communication strategic algorithm and authentication information are obtained in advance from the communication device 100A in the process shown in FIG. 3. When the communication between the communication devices 100A and 100B is disconnected after the exchange of content data is initiated between the communication devices 100A and 100B, the memory card 108 stored with the communication strategic algorithm and authentication information is inserted into the personal computer 200. Thus, communication between the communication device 100A and the personal computer 200 can be resumed.

In this time, the communication device 100B can store content data obtained from the communication device 100A in the memory card 108. Thus, the communication device 100B can store the content data stored in the memory card 108 on the personal computer 200 when the communication between the communication device 100A and the personal computer 200 into which the memory card 108 is inserted is resumed after the communication between the communication devices 100A and 100B is disconnected.

### <2. Summary and Conclusion>

As described above, the communication device 100A and the communication device 100B that are included in the communication system 1 according to the embodiment of the present disclosure exchange information in advance between the communication device 100A and the communication device 100B before the communication device 100A transmits content data to the communication device 100B. The previously exchanged information is related to the communication between the communication devices 100A and 100B.

The information regarding communication between the communication devices 100A and 100B may be exchanged, for example, using short-range wireless communication between the communication devices 100A and 100B. The previous exchange of information between the communication device 100A and the communication device 100B makes it possible to prevent the authentication mechanism from being exchanged whenever switching is performed even if the communication mechanism is switched one after another, thereby allowing the user to be unaware of switching of communication mechanism and thereby being capable of exchanging data seamlessly.

Since the switching algorithm of communication mechanism is shared between the communication devices 100A and 100B at the time of initiating the communication between the communication devices 100A and 100B, the communication devices 100A and 100B can switch automatically a plurality of communication mechanisms without causing the user to become aware of the switching. In addition, since the switching algorithm of communication mechanism is shared between the communication devices 100A and 100B, the communication devices 100A and 100B can automatically switch a communication mechanism into a new one even when the communication for performing the switching of communication mechanism has not been performed.

Furthermore, when the communication mechanism between the communication devices 100A and 100B is switched, the communication devices 100A and 100B continue to receive and transmit data without re-transmitting data which has previously received and transmitted. Thus, it is possible to prevent unwanted traffic from occurring when a communication mechanism is switched, and a receiving-side can obtain the desired data immediately even when the communication is switched.

The process illustrated in the embodiment described above may be performed in hardware or software. When the process illustrated in each of the embodiments described above is performed in software, a controller such as a CPU incorporated in the communication device 100A or the communication device 100B may read out sequentially a computer program stored in a recording medium such as ROM, HDD, SSD, or the like, and may execute the program.

It should be understood by those skilled in the art that various modifications, combinations, sub-combinations and alterations may occur depending on design requirements and other factors insofar as they are within the scope of the appended claims or the equivalents thereof.

For example, in the above embodiments, information is exchanged between the communication devices 100A and 100B before content data is transferred using short-range wireless communication, but the communication mode which can be used in the exchange of information prior to the transfer of content data is not limited to the above embodiments. For example, information may be exchanged between the communication devices 100A and 100B using the IrDA standard protocol instead of short-range wireless communication. In addition, for example, a two-dimensional barcode may be used in the exchange of information prior to transferring content data. When the communication device 100A is provided with a camera, a two-dimensional barcode in which available communication modes are embedded is displayed on the display unit 102 of the communication device 100B and the camera captures the two-dimensional barcode, thereby facilitating the exchange of information between the communication devices 100A and 100B.

Furthermore, for example, if the communication device 100A is disconnected from the communication device 100B when the communication device 100A transmits content data to the communication device 100B, the communication device 100A may allow the display unit 102 to display available communication modes which are previously exchanged between the communication devices 100A and 100B. By allowing the display unit 102 to display available communication modes which are previously exchanged between the communication devices 100A and 100B, the user can determine which communication mode is used to transmit content data. Of course, the communication device 100B that receives content data may cause the display unit 102 to display available communication modes.

Additionally, the present technology may also be configured as below.

(1) A communication device including:

a communication unit configured to include different communication modes; and

an information exchange unit configured to exchange, before the communication unit transmits information to a transmission destination device, an available communication mode and authentication information in advance with the transmission destination device using a communication mode included in the communication unit, the authentication information being used when communication is performed using the communication mode.

(2) The communication device according to (1), wherein, when the communication unit is disconnected from the transmission destination device in transmitting information to the transmission destination device, the communication unit selects a communication mode different from the available communication mode exchanged by the information exchange unit, authenticates the transmission destination device using the authentication information exchanged by the information exchange unit, and resumes transmission of information to the transmission destination device.

(3) The communication device according to (2), wherein the communication unit is configurable to set a timeout period for the available communication mode exchanged by the information exchange unit.

(4) The communication device according to (2) or (3), wherein, when the communication unit resumes transmission of information to the transmission destination device, the communication unit transmits, to the transmission destination device, information following the information that has been already transmitted.

(5) The communication device according to any one of (2) to (4), wherein, when selecting a different communication mode, the communication unit selects a communication mode based on a priority.

(6) The communication device according to (5), wherein, when selecting a different communication mode, the communication unit sets a timeout period to be longer as the priority becomes lower.

(7) The communication device according to any one of (1) to (6), further including:

an information presentation unit configure to present the available communication mode exchanged by the information exchange unit when the communication unit is disconnected from the transmission destination device in transmitting information to the transmission destination device.

(8) The communication device according to any one of (1) to (7), further including:

a storage unit for storing information related to the available communication mode exchanged by the information exchange unit.

(9) The communication device according to (1), wherein the information exchange unit exchanges the available communication mode and the authentication information with the transmission destination device using short-range wireless communication, the authentication information being used when communication is performed using the communication mode.

(10) A communication device including:

a communication unit configured to include different communication modes; and

an information exchange unit configured to exchange, before the communication unit receives information from a transmission source device, an available communication mode and authentication information in advance with the transmission source device using a communication mode included in the communication unit, the authentication information being used when communication is performed using the communication mode.

(11) A communication method including:

communicating using one communication mode of different communication modes; and

exchanging, before information is transmitted to a transmission destination device in the communicating step, an available communication mode and authentication information in advance with the transmission destination device using a communication mode of the different communication modes, the authentication information being used when communication is performed using the communication mode.

(12) A computer program for causing a computer to execute:

communicating using one communication mode of different communication modes; and

exchanging, before information is transmitted to a transmission destination device in the communicating step, an available communication mode and authentication information in advance with the transmission destination device using a communication mode of the different communication modes, the authentication information being used when communication is performed using the communication mode.

(13) A communication system including:

a transmitting device configured to transmit information; and

a receiving device configured to directly or indirectly receive the information transmitted by the transmitting device,

wherein the transmitting device includes
a communication unit configured to include different communication modes, and
an information exchange unit configured to exchange an available communication mode and authentication information in advance with the receiving device using a communication mode included in the communication unit before the communication unit transmits information to the receiving device, the authentication information being used when communication is performed using the communication mode, and

wherein the receiving device includes
a communication unit configured to include different communication modes, and
an information exchange unit configured to exchange an available communication mode and authentication information in advance with the transmitting device using a communication mode included in the communication unit before the communication unit receives information from the transmitting device, the authentication information being used when communication is performed using the communication mode.

The present disclosure contains subject matter related to that disclosed in Japanese Priority Patent Application JP 2012-113116 filed in the Japan Patent Office on May 17, 2012, the entire content of which is hereby incorporated by reference.

What is claimed is:

1. A communication device comprising:
a communication unit configured to include different communication modes; and
an information exchange unit configured to exchange, before the communication unit transmits information to a transmission destination device, an available communication mode and authentication information in advance with the transmission destination device using a communication mode included in the communication unit, the authentication information being used when communication is performed using the communication mode.

2. The communication device according to claim 1, wherein, when the communication unit is disconnected from the transmission destination device in transmitting information to the transmission destination device, the communication unit selects a communication mode different from the available communication mode exchanged by the information exchange unit, authenticates the transmission destination device using the authentication information exchanged by the information exchange unit, and resumes transmission of information to the transmission destination device.

3. The communication device according to claim 2, wherein the communication unit is configurable to set a timeout period for the available communication mode exchanged by the information exchange unit.

4. The communication device according to claim 2, wherein, when the communication unit resumes transmission of information to the transmission destination device, the communication unit transmits, to the transmission destination device, information following the information that has been already transmitted.

5. The communication device according to claim 2, wherein, when selecting a different communication mode, the communication unit selects a communication mode based on a priority.

6. The communication device according to claim 5, wherein, when selecting a different communication mode, the communication unit sets a timeout period to be longer as the priority becomes lower.

7. The communication device according to claim 1, further comprising:
an information presentation unit configure to present the available communication mode exchanged by the information exchange unit when the communication unit is disconnected from the transmission destination device in transmitting information to the transmission destination device.

8. The communication device according to claim 1, further comprising:
a storage unit for storing information related to the available communication mode exchanged by the information exchange unit.

9. The communication device according to claim 1, wherein the information exchange unit exchanges the available communication mode and the authentication information with the transmission destination device using short-range wireless communication, the authentication information being used when communication is performed using the communication mode.

10. A communication device comprising:
a communication unit configured to include different communication modes; and
an information exchange unit configured to exchange, before the communication unit receives information from a transmission source device, an available communication mode and authentication information in advance with the transmission source device using a communication mode included in the communication unit, the authentication information being used when communication is performed using the communication mode.

11. A communication method comprising:
communicating using one communication mode of different communication modes; and
exchanging, before information is transmitted to a transmission destination device in the communicating step, an available communication mode and authentication information in advance with the transmission destination device using a communication mode of the different communication modes, the authentication information being used when communication is performed using the communication mode.

12. A computer program for causing a computer to execute:
communicating using one communication mode of different communication modes; and
exchanging, before information is transmitted to a transmission destination device in the communicating step, an available communication mode and authentication information in advance with the transmission destination device using a communication mode of the different communication modes, the authentication information being used when communication is performed using the communication mode.

13. A communication system comprising:
a transmitting device configured to transmit information; and
a receiving device configured to directly or indirectly receive the information transmitted by the transmitting device,
wherein the transmitting device includes
a communication unit configured to include different communication modes, and
an information exchange unit configured to exchange an available communication mode and authentication information in advance with the receiving device using a communication mode included in the communication unit before the communication unit transmits information to the receiving device, the authentication information being used when communication is performed using the communication mode, and
wherein the receiving device includes
a communication unit configured to include different communication modes, and
an information exchange unit configured to exchange an available communication mode and authentication information in advance with the transmitting device using a communication mode included in the communication unit before the communication unit receives information from the transmitting device, the authentication information being used when communication is performed using the communication mode.
